(19) United States
(12) Patent Application Publication
(10) Pub. No.: US 2008/0027573 A1
(43) Pub. Date: Jan. 31, 2008

(54) Audio apparatus

(75) Inventors: Takanori Yamamoto, Kawachi-gun (JP); Morihiro Inomata, Utsunomiya-shi (JP); Shinichiro Goto, Utsunomiya (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD.

(21) Appl. No.: 11/826,409

(22) Filed: Jul. 16, 2007

(30) Foreign Application Priority Data
Jul. 25, 2006 (JP) 2006-201985

(51) Int. Cl. G06F 17/00

(52) U.S. Cl. 700/94

(57) ABSTRACT

This audio apparatus includes: a property data obtain device which obtains a property data appended to music data on playing; a command generation device which generates specific commands for each of operation devices; a command registration device which registers the commands generated by the command generation device, to a database when the operation devices have been operated for equal to or more than a predetermined time, so as to correspond to the property data appended to the music data on playing; and a property data search device which searches the command generated by the command generation device when the operation devices are operated for less than the predetermined time, searches the property data that corresponds to the command, and transfer the found property data to the external storage terminal device.

### BACKGROUND OF THE INVENTION

Priority is claimed on Japanese Patent Application No. 2006-201985, filed Jul. 25, 2006, the contents of which are incorporated herein by reference.

1. Field of the Invention

The present invention relates to an audio apparatus that is mounted in a vehicle or the like.

2. Description of the Related Art

Recently, a portable player becomes widely popular which plays data such as music data and movie data stored in a storage medium such as a memory or a hard disc. In this kind of portable player, new products having a larger storage capacity have been manufactured, and the storable quantity of data also has been increasing. This kind of music data and movie data has tags (i.e., property data) including identification data. For example, the tag of the music data has the identification data for each category such as an artist name, an album title, a music title, and a genre. By displaying the identification data of the tag onto a liquid crystal display or the like of a portable music player, a user can identify the music data on playing. In addition, some of the portable players have a function of searching and finding specific data based on the identification data of the tag appended to the plural data stored in a storage medium. The data found by this function is registered to a playlist; and the data registered in the playlist are sequentially played by a playing operation by the user.

Furthermore, recently, a vehicle mounted data-searching device is proposed which searches and finds audio data stored in a storage medium of the above-mentioned portable type player connected to a device such as a vehicle mounted audio apparatus having a playing function (for example, refer to Japanese Unexamined Patent Application, First Publication No. 2002-373484). Furthermore, in this kind of data-searching devices, one is proposed which utilizes searching and finding functions of the portable player. In this data-searching device, searching and finding of the data in the portable player can be performed by operating an operation system of the vehicle mounted audio apparatus.

However, the data-searching device which searches the desired data in the portable player requires the user to perform complicated constricting-operations in which the categories of tags displayed on a screen or the like of the vehicle mounted device are sequentially selected and constricted. Accordingly, for example, there is a case in which the user cannot search the desired data in the portable player easily while driving a vehicle.

The present invention was made in view of the above-mentioned circumstances and has an object of providing an audio apparatus which enables a user to easily search the desired data stored in an external storage terminal device.

### SUMMARY OF THE INVENTION

The present invention employed the followings in order to achieve the above-mentioned object.

That is, the present invention employed an audio apparatus to which an external storage terminal device storing a music data is connectable, and which can search and play the music data stored in the external storage terminal device by operating operating devices, the audio apparatus provided with: a property data obtain device which obtains a property data appended to the music data on playing; a command generation device which generates specific commands for each of the operation devices; a command registration device which registers the commands generated by the command generation device, to a database when the operation devices have been operated for equal to or more than a predetermined time, so as to correspond to the property data appended to the music data on playing; and a property data search device which searches the command generated by the command generation device when the operation devices are operated for less than the predetermined time, searches the property data that corresponds to the command, and transmits the found property data to the external storage terminal device.

According to the audio apparatus, when the audio apparatus plays the audio data stored in the external storage terminal device, if the operation devices are operated for equal to or more than the predetermined time which was set in advance, the command generation device generates the commands for each of the operation devices, and the command registration device stores the commands to the database so as to correspond the property data appended to the audio data now on playing. Accordingly, the commands can be registered easily so as to correspond to the property data only by operating the operation devices while playing the audio data.

In addition, by operating the operation devices for less than the predetermined time which was set in advance, it is possible to: search the commands generated for each operation devices in the database, by the property data search device; call the property data corresponded to the command in the database; and transmit the property data to the external storage terminal device. Therefore, it is possible to call the audio data from the external storage terminal device based on the property data. Accordingly, the audio data can be found easily from the external storage terminal device with simple operations of the operation devices.

It may be arranged such that: the property data includes identification data for each categories; and the command is registered to the database so as to correspond to at least one of the identification data appended to the property data.

In this case, the audio data can be called from the external storage terminal device based on the plural categories of the identification data appended to the property data. Accordingly, it is possible to increase the degree of freedom for calling the audio data.

The command may be registered as a search key to the database.

In this case, by operating the operation devices, the command can be stored as a search key to the database so as to correspond to the property data. Accordingly, the desired audio data can be searched quickly from the external storage terminal device based on the stored search key.

The audio apparatus may be further provided with a display device which displays the property data in a format which indicates at least one part thereof.

In this case, a user can identify the property data through a display of the display device.

### BRIEF DESCRIPTION OF THE DRAWINGS

FIG. 1 is a view showing a whole construction of an audio unit according to one embodiment of the present invention.

FIG. 2 is a view showing a functional construction of a data-calling controller of the embodiment.

FIG. 3 is a flowchart showing a search-key registration process of the embodiment.

FIG. 4 is a flowchart of a data-calling process by a preset switch of the embodiment.

FIG. 5 is an explanatory view of music data and tags of the embodiment.

FIG. 6 is an explanatory view of categories of the tags and identification data of the embodiment.

FIG. 7 is an explanatory view of a database DB in a storage section 18 of the embodiment.

### DETAILED DESCRIPTION OF THE INVENTION

One embodiment of an audio apparatus according the present invention will be explained below with reference to the drawings.

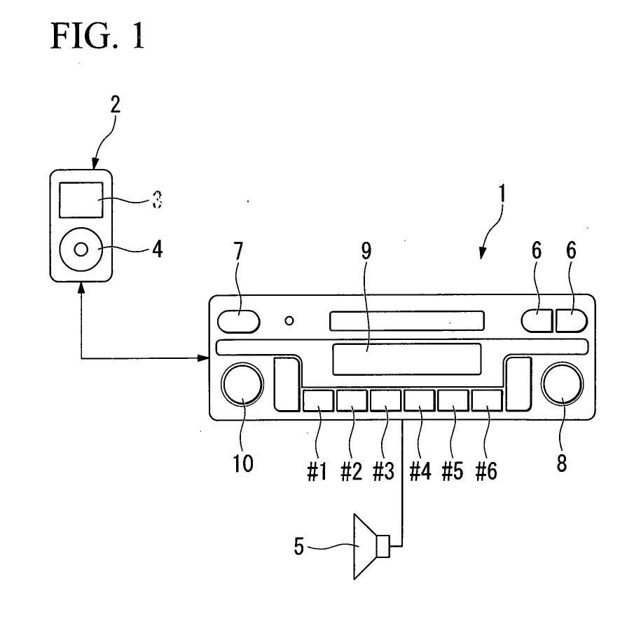

FIG. 1 is a general construction view of an audio unit (audio apparatus) according to the present embodiment. This audio unit 1 is installed in a vehicle such as a car, and is constructed so as to be detachably connected with a mobile-type multimedia player (external storage terminal device) 2 via an interface such as Bluetooth (registered trademark) which is a near-field wireless communication.

The multimedia player 2 is a so-called portable player. When this multimedia player 2 is unconnected to the audio unit 1, normally, a user can enjoy music and movies at outdoors by plugging a plug of a headphone into an analogue terminal of the audio unit 1. Further, this multimedia player 2 is also constructed so as to be able to perform an interactive communication through an interface such as USB (Universal Serial Bus) with a terminal device such as a non-illustrated PC (Personal Computer) or a server. With this terminal device, it is possible to perform data-control such as transmission of music data and movie data to a storage medium such as HDD (Hard Disk Drive) or RAM (Random Access Memory) installed in the multimedia player 2, editing, or the like.

Moreover, the multimedia player 2 and the audio unit 1 may be connected with each other through a wired interface such as USB, as same as the above-mentioned connection with the PC.

Plural music data and movie data stored in the above-mentioned storage medium of the multimedia player 2 are appended with tags which are property data for identifying these music data and movie data. A user can find and play the desired music data or movie data by operating an operation section 4 to perform a selection, playing, and stopping of the music data or the movie data, while confirming the identification data of the tags displayed on a display 3 of the multimedia player 2. The above-mentioned tags are appended with identification data (as text data) which are categorized in plural categories such as “title (music title)”, “artist”, “album”, “genre”, “wording included in comments which are registered in advance”, “year, month, and date of a release of the album”, “year, month, and date of generation of the data”. The multimedia player 2 has a function of searching the music data or the movie data based on these identification data.

On the other hand, the audio unit 1 is a so-called audio head unit which utilizes by switching, in accordance with necessity, functions of an AM/FM radio tuner (hereinafter “tuner mode”) and a playing functions of a magneto-optical disc (hereinafter “player mode”) or the like. This audio unit 1 is connected with plural speakers 5 arranged in a cabin interior of a vehicle. In addition, on a front face of the audio unit 1, there is provided with: mode-switching switches 6 for switching the modes between the tuner mode and the player mode; an ejection switch 7 for ejecting a medium such as a magneto-optical disc; a volume switch 8 for adjusting the volume; plural preset switches (operation devices) #1 to #6 for memorizing radio frequencies of AM/FM channels while selecting the tuner mode; and a liquid crystal display section (display device) 9 for displaying information such as the radio frequency of the currently selected channel, or a track information of the medium on playing. While the audio unit 1 is not in the tuner mode, other functions are assigned to the preset switches #1 to #6, such as a function of switching displaying modes of the liquid crystal display 9.

In addition, the audio unit 1 is constructed so as to be able to play music data transmitted from the multimedia player 2. For example, when the audio unit 1 plays the music data, the audio data is played to drive the speakers 5 arranged in the cabin interior, while displaying the information of the tags appended to the audio data (for example, identification data such as artist, album) on the liquid crystal display 9 which is provided so as to be able to display it in a format which indicates at least one part thereof. Moreover, in the audio unit 1, the mode of playing the audio data transmitted from the multimedia player 2 may be arranged so as to be switched when a connection with the multimedia player 2 is detected, or so as to be switched by providing and operating a mode-switching switch. Moreover, the above-mentioned “so as to be able to display it in a format which indicates at least one part thereof” is for the case where all characteristics of the identification data are not displayable (that is, for example, the case where the number of characteristics displayable on the liquid crystal display 9 is smaller than the number of characteristics the identification data, or the like), and means displaying wording having a content which enables the user to identify the identification data itself (for example, displaying only an initial of the identification data, or displaying displayable number of characteristics on the liquid crystal display 9).

The audio unit 1 is constructed so as to be able to perform remote operations of the operation section 4 of the multimedia player 2 when the multimedia player 2 is connected thereto. That is, when the user performs operations such as searching the desired data among the music data, playing, stopping, and fast-winding, the user can use the functions of the multimedia player 2 by operating operation sections (for example, a rotating-operation section 10 for a tuner, or the like) of the audio unit 1.

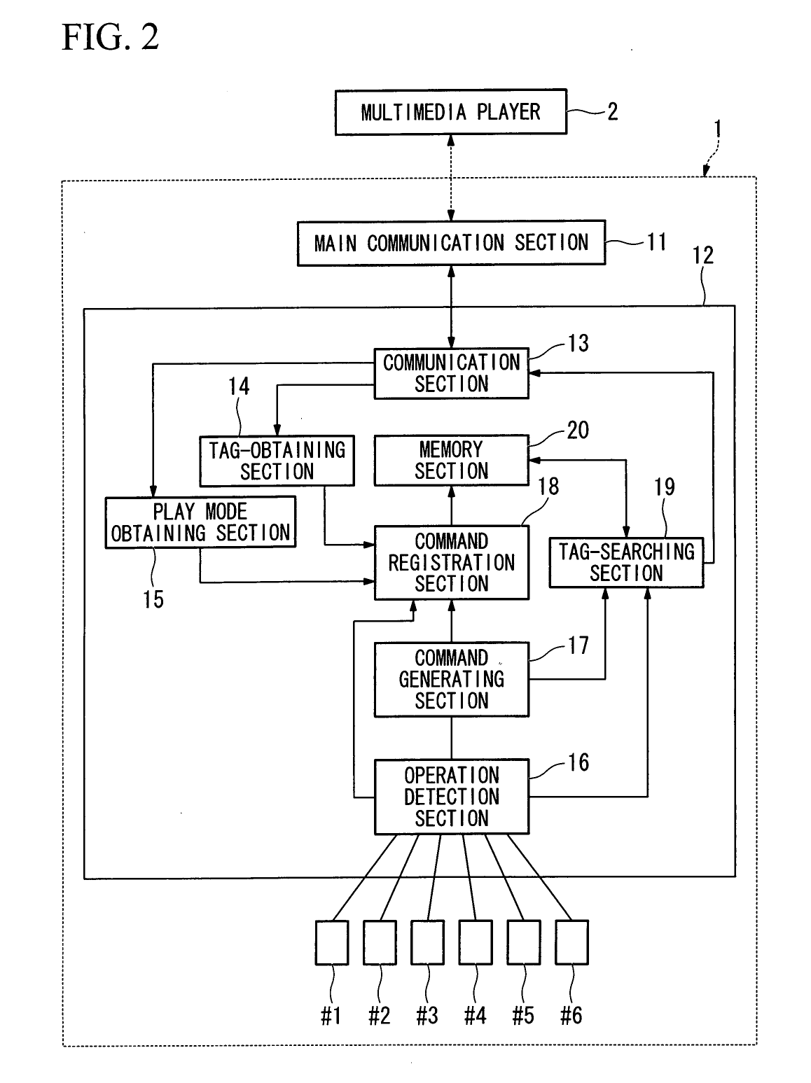

The above-mentioned audio unit 1 is provided with a data-calling controller 12 which calls desired music data from the multimedia player 2. The data-calling controller 12 will be explained below with reference to FIG. 2.

As shown in FIG. 2, the audio unit 1 is provided with a main communication section 11 which forms a part of an interface with the above-mentioned multimedia player 2, and the main communication section 11 is connected with a communication section 13 of the data-calling controller 12. Moreover, the main communication section 11 is can be connected with a controller which controls functions such as playing of the audio unit 1 (however, these are omitted in the drawings). Moreover, the present embodiment shows an example in which the multimedia player 2 and the communication section 13 are connected via the main communication section 11; however, it may be arranged such that the communication section 13 and the multimedia player 2 are directly connected with each other by omitting the main communication section 11. In this case, the music data transmitted from the multimedia player 2 can be transferred to the controller of the audio unit 1 through the communication section 13.

The communication section 13 is connected with a tag-obtaining section (property data obtaining section) 14 in the data-calling controller 12. The tag-obtaining section 14 can obtain tags appended to the music data which is currently played. When the tag-obtaining section 14 obtains the tags of the music data, the tag-obtaining section 14 temporarily stores the obtained tags. Moreover, since the tags are always transferred and received together with the music data, the obtainable tags are limited to those of the music data currently played by the audio unit 1.

Furthermore, the communication section 13 is connected with a play mode obtaining section 15 which obtains a play mode of the music data currently played by the audio unit 1. The play mode obtaining section 15 finds which category in the tags appended to the music data currently on playing is referred to, to call the music data on playing.

On the other hand, as explained in the above, the data-calling controller 12 is connected with the plural preset switches #1 to #6, and operations of these preset switches #1 to #6 are detected by an operation detection section (detection section) 16. The detected operation information of the preset switches #1 to #6 are transferred to a command generating section 17, a command registration section 18, and a tag-searching section (property data search device) 19, respectively.

The command generating section 17 generates searching commands for each of the preset switches #1 to #6, respectively, based on the detection information transmitted from the operation detection section 16. More specifically, for example, when the preset switch #1 among the preset switches #1 to #6 is operated, a search command “#1” which was set in advance so as to correspond to the preset switch #1, is generated. This command is generated only by an operation of the preset switch #1, and respective commands are assigned in advance to the other preset switches #2 to #6. Moreover, the searching command is not limited only to the “#1”, and other distinguishable searching commands can be assigned.

When the operation detection section 16 detects that any one of the preset switches #1 to #6 is operated for equal to or more than a predetermined time (for example, about two seconds), the command registration section 18 stores the identification data of the category appended to the tag and the search command generated by the command generating section 17 so as to correspond with each other, into the storage section 20, based on the tag obtained by the tag-obtaining section 14 and the play mode obtained by the play mode obtaining section 15. More specifically, for example, when the music data now on playing is played by being searched with the category “artist” appended to the tag, the play mode obtaining section 15 obtains the category “artist” while the tag-obtaining section 14 obtains the tag of the music data on playing. Then, the command registration section 18 makes the search command transmitted from the command generating section 17 correspond to the identification data (for example, “HATSUMEI TARO” shown in FIG. 6) of the category “artist” of the tag, and then stores them to the database DB of the storage section 20. Moreover, the present embodiment showed an example in which the music data is searched using the category of “artist”; however, of course, it is possible to register the identification data and the search command to the database DB of the storage section 20 so as to correspond with each other, even for the music data searched by the category other than the “artist”.

When the operation detection section 16 detects that any one of the preset switches #1 to #6 is operated for equal to or more than a predetermined time (for example, about two seconds), the tag-searching section 19 searches the search key from the database DB of the storage section 20, using this search command as a search key, which was generated in the command generating section 17 by operating the preset switches. Then, if the corresponding search key was found in the database DB, the identification data corresponding to this search key is called, and is transmitted to the multimedia player 2. Here, by transferring the identification data to the multimedia player 2, the music data stored in the multimedia player 2 is searched based on this identification data.

More specifically, when for example the preset switch #1 is operated in a short time less than a predetermined time, the tag-searching section 19 receives the search command “#1” which was set to the preset switch #1 in advance from the command generating section 17, and searches in the database DB of the storage section 20 using this search command “#1” as a search key. Then, if the “#1” being a search key was found in the database DB, as shown in FIG. 7 for example, the tag-searching section 19 then transmits the identification data of for example “HATSUMEI TARO” in the category “artist” which was corresponded to the “#1”, to the multimedia player 2.

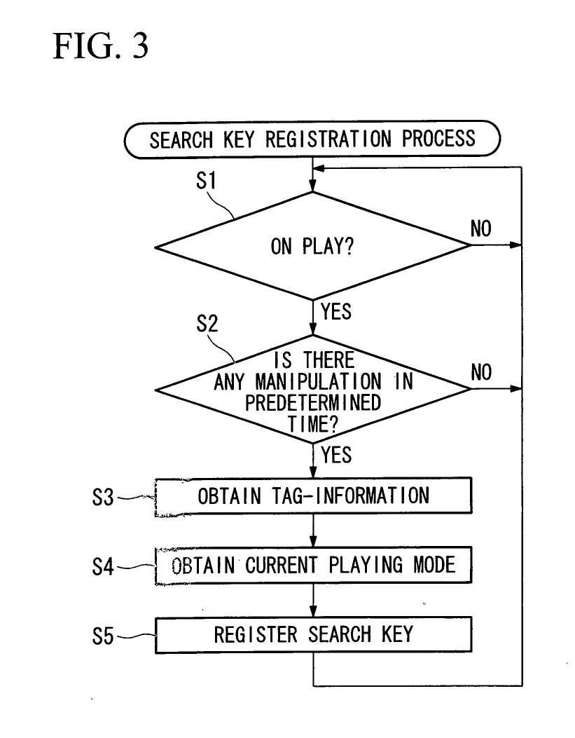

Next, the registration process of the search key in the data-calling controller 12 will be explained below with reference to a flowchart shown in FIG. 3.

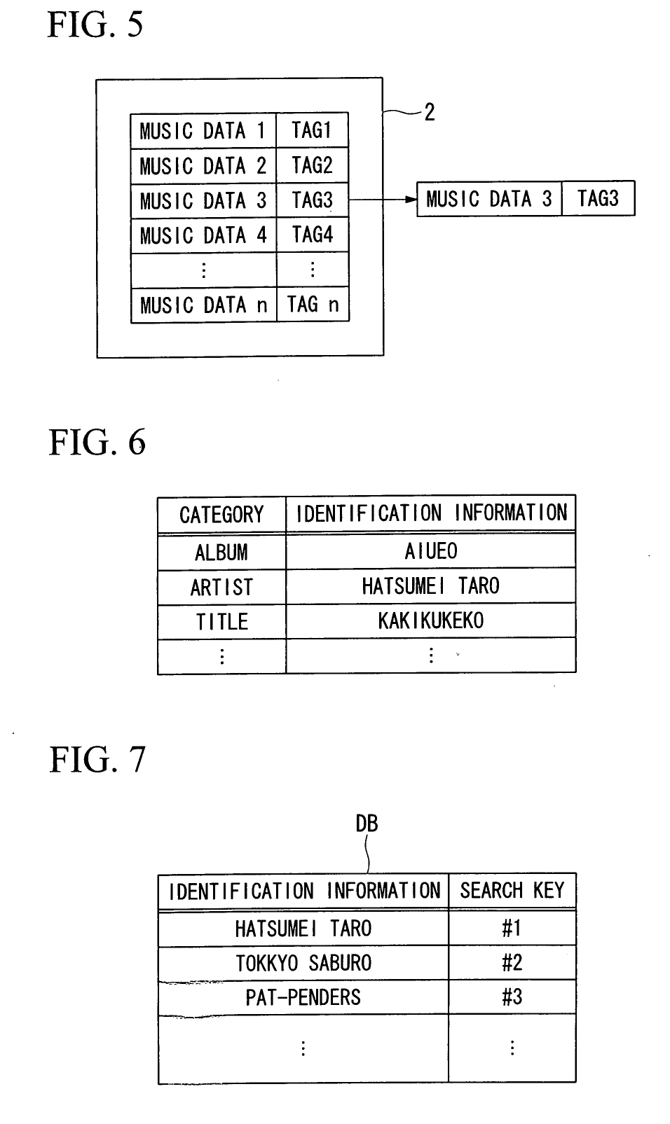

Firstly, in a step S1, it is determined whether the music data is now on playing or not. That is, the music data is transferred from the multimedia player 2 to the audio unit 1, and is determined whether it is currently on playing or not. If the determination result is “YES” (on playing), then the process proceeds to a step S2, while if the determination result is “NO” (not on playing), then the process repeats the process of the step S1. Here, FIG. 5 indicates for example the case in which music data 3 was called among music data 1 to n (where “n” is a natural number) stored in the multimedia player 2; only the music data 3 to be played will be transferred to the audio unit 1.

In the step S2, the command registration section 18 determines whether any one of the preset switches #1 to #6 was operated for equal to or more than the predetermined time or not based on the detection results of the operation detection section 16. If the determination is “YES” (there was the operation), then the process proceeds to a step S3, while if the determination is “NO” (there was no operation), then the process returns to the step S1 and repeats the above-mentioned process.

In the step S3, the tag appended to the music data is obtained by the tag-obtaining section 14. Here, FIG. 6 shows one example of the tag obtained from the music data on playing. As shown in FIG. 6, the tag is provided with the categories such as “album”, “artist”, and “title”; and the identification data is respectively assigned (for example, “AIUEO” is assigned to “album”, “HATSUMEI TARO” is assigned to “artist”, and “KAKIKUKEKO” is assigned to “title”).

In step S4, the play mode of the music data currently on playing (i.e., which category was based for searching the music data) is obtained from the controller of the audio unit 1. Here, the category obtained in the step S4 includes “wording included in comments which were registered in advance”, “year, month, and date of a release of the album”, “year, month, and date of generation of the data”, which are omitted in FIG. 6, in addition to the categories shown in FIG. 6, such as “album”, “artist”, “title”, and the like.

Further in step S5, the command registration section 18 registers the search command generated by the command generating section 17 so as to correspond as a search key to the identification data of the category determined in the step S4, to the database DB of the storage section 20; and thereafter, the process returns to the step S1. Here, when the preset switch #1 is operated and the category “artist” is obtained in the step S4, the identification data of “artist” appended to the tag obtained by the tag-obtaining section 14 (for example, the identification data “HATSUMEI TARO” shown in FIG. 6) is registered so as to correspond to “#1” being a search key, to the database DB having the identification data and the search key shown in FIG. 7. Moreover, the cases for the categories other than “artist” are the same as the above. For example, when the category is “album”, the identification data “AIUEO” shown in FIG. 6 is registered to the database DB so as to correspond to the search key.

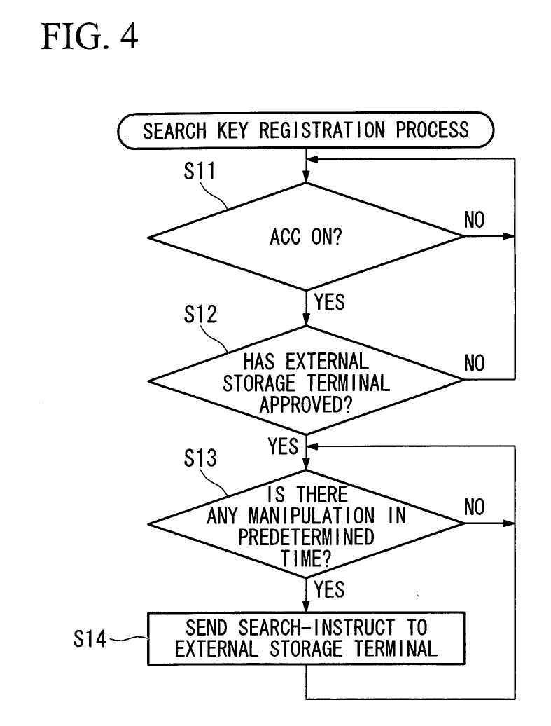

Next, a search key registration process for calling the music data stored in the multimedia player 2 by operating the preset switches will be explained below with reference to FIG. 4.

Firstly, in step S11, it is determined whether an accessory battery (ACC) of a vehicle is ON or not. If the determination is “YES” (i.e., ACC is ON), then the process proceeds to step S12, while if the determination is “NO” (i.e., ACC is OFF), then the process returns to step S11.

In the step S12, it is determined whether the multimedia player 2 being the external storage terminal device is recognized or not (i.e., whether the multimedia player 2 is connected to the audio unit 1 or not). If the determination result is “YES” (recognized), then the process proceeds to step S13, while if the determination result is “NO” (unrecognized), then the process returns to the step S11 to repeat the above-mentioned process.

In the step S13, it is determined based on the detection result of the operation detection section 16, whether any one of the preset switches #1 to #6 is operated for less than the predetermined time or not. If the determination result is “YES” (there was the operation), then the process proceeds to step S14, while if the determination result is “NO” (there was no operation), then the process of the step S13 is repeated.

In the step S14, the search command generated by the command generating section 17 is searched as the search key in the database DB of the storage section 20. The identification data corresponded to the found search key is transferred via the communication section 13 to the multimedia player 2, and the process returns to the step S13 to repeat the above-mentioned process. More specifically, when the preset switch #1 among the preset switches #1 to #6 is operated, if the search command generated by the command generating section 17 is for example “#1”, this “#1” is searched among the search keys in the database DB of the storage section 20, to call “HATSUMEI TARO” being an identification data corresponded to this “#1”, from the database DB. Then, this identification data “HATSUMEI TARO” is transferred to the multimedia player 2. With this process, the music data appended with the tag including the identification data “HATSUMEI TARO” is searched in the multimedia player 2, and the searched music data is sequentially transferred to the audio unit 1. Moreover, the above explanation was made for the cases of operating the preset switch #1; however, the same explanation can be applied for the case of operating other preset switches #2 to #6. The above explanation was made for the audio unit 1 having six preset switches; however, the number of the preset switches can be changed in accordance with the arrangement space therefor (for example, a construction having only one preset switch can be employed).

According to the present embodiment, while playing the music data stored in the multimedia player 2, by operating any one of the preset switches #1 to #6 for equal to or more than the predetermined time which was set in advance, the command generating section 17 generates the search command for any one of the operated preset switches #1 to #6, and thereby enabling the command registration section 18 to store the found search command to the storage section 20 so as to correspond to the identification data of the tag appended to the music data on playing. Accordingly, it is possible to easily register the search key so as to correspond to the identification data of the tag only by operating any one of the preset switches #1 to #6 for equal to or more than the predetermined time, while playing the music data.

Furthermore, by operating any one of the preset switches #1 to #6 for less than the predetermined time which was set in advance, it is possible to: search the database DB of the storage section 20 using the search commands as a search keys, which were generated for each of the preset switches #1 to #6 respectively by the tag-searching section; call the identification data to which the search key was corresponded; and transmit the identification data to the multimedia player 2. Therefore, it is possible to call the music data from the multimedia player 2 based on the found identification data. Accordingly, it is possible to easily call the music data from the multimedia player 2 with simple operations of the preset switches #1 to #6.

Furthermore, since it is possible to call the music data from the multimedia player 2 based on the identification data of the plural categories appended to the tags, the degree of freedom for selecting the data can be increased.

In addition, since the identification data of the tag is displayed on the liquid crystal display 9 in a format which indicates at least one part thereof, the user can easily identify the identification data of the tag.

Moreover, the present embodiment showed an example of playing the music data transferred from the multimedia player 2; however, the data to be played is not only limited to the music data, and can be other data such as audio data recorded by the user, audio data appended to the movies, or the like.

In addition, in the present embodiment, the music data having tags (i.e., the digital music data) is transferred to the audio unit 1 to play it on the audio unit 1. However, it may be arranged such that: the music data is played on the multimedia player 2 for example, to input analogue signal for a headphone for example, into the audio unit 1 through a wired or wireless communication; and the audio unit 1 just amplifies the transferred analog signal to output it from speakers. In this case, it is possible to perform the registration process of the search keys by transferring the music data on playing on the multimedia player 2 from the multimedia player 2 to the data-calling controller 12 of the audio unit 1.

In addition, the present embodiment showed a case in which the data-calling controller 12 is unitarily provided together with the audio unit 1; however, the data-calling controller 12 may be provided so as to be independent from the audio unit 1.

While a preferred embodiment of the invention has been described and illustrated above, it should be understood that this is an exemplary of the invention and is not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An audio apparatus to which an external storage terminal device storing a music data is connectable, and which can search and play the music data stored in the external storage terminal device by operating operating devices, the audio apparatus comprising:
a property data obtain device which obtains a property data appended to the music data on playing;
a command generation device which generates specific commands for each of the operation devices;
a command registration device which registers the commands generated by the command generation device, to a database when the operation devices have been operated for equal to or more than a predetermined time, so as to correspond to the property data appended to the music data on playing; and
a property data search device which searches the command generated by the command generation device when the operation devices are operated for less than the predetermined time, searches the property data that corresponds to the command, and transfer the found property data to the external storage terminal device.

2. The audio apparatus according to claim 1, wherein:
the property data includes identification data for each categories; and
the command is registered to the database so as to correspond to at least one of the identification data appended to the property data.

3. The audio apparatus according to claim 1, wherein the command is registered as a search key to the database.

4. The audio apparatus according to claim 1, further comprising a display device which displays the property data in a format which indicates at least one part thereof.
